(19) United States
(12) Patent Application Publication
(10) Pub. No.: US 2025/0303789 A1
(43) Pub. Date: Oct. 2, 2025

(54) OMNIDIRECTIONAL ROLLER WHEEL WITH SOLD BUSHING AND SYMMETRICAL AXLE

(71) Applicant: Lab67 Co., Las Vegas, NV (US)

(72) Inventor: David Bruce McCalib, JR., Washougal, WA (US)

(73) Assignee: Lab67 Co., Las Vegas, NV (US)

(21) Appl. No.: 19/096,116

(22) Filed: Mar. 31, 2025

Related U.S. Application Data
(60) Provisional application No. 63/572,122, filed on Mar. 29, 2024.

(51) Int. Cl. B60B 19/00; B60B 19/12; B60B 31/00

(52) U.S. Cl. CPC B60B 19/003; B60B 19/12; B60B 31/00; B60B 2200/43; B60B 2310/204; B60B 2310/3025; B60B 2310/321; B60B 2320/10; B60B 2360/30

(57) ABSTRACT

A wheel assembly is composed of multiple wheels, each featuring a hub with spokes and a main axle bore, and cross-roller sub-assemblies that include symmetrical axles and solid bushings, as well as peripheral rollers. The cross-roller sub-assemblies are overmolded with the wheel hub to form a peripheral axle ring. A method of assembling the wheel assembly involves creating the cross-roller sub-assemblies by overmolding the solid bushings with peripheral rollers, and then placing these sub-assemblies in a mold to form the peripheral axle ring. Alternatively, the pre-roller assemblies may be overmolded directly with the wheel hub to form the peripheral axle ring.

### CROSS-REFERENCE TO RELATED APPLICATIONS

This application claims the benefit of U.S. provisional patent application Ser. No. 63/572,122, filed on Mar. 29, 2024, the contents of which are incorporated herein by reference in their entirety.

### BACKGROUND

Omnidirectional wheels have been in production for many years. Conventional omnidirectional wheels fall into a class of wheels for which there is a main or primary rotational direction around a main axis, with cross rollers added to allow transverse motion (along, rather than around, the main axis). Common examples of such omnidirectional wheels are Mecanum wheels or Rotacasters. In all cases, conventional omnidirectional wheels either rely on split bushings or employ multiple sub-assemblies that are brought together at the final assembly to enclose the cross rollers.

These features and methods may necessitate complex, difficult, and time-consuming assembly of smaller parts that may then need to be placed in molds for the overmolding process. Additionally, split or clamshell-style bushings are weaker than solid-style bushings and may lead to failures that might be avoided, while solid-style bushings may necessitate additionally complex assembly steps.

There is, therefore, a need for an omnidirectional wheel design and a manufacturing process that provides the flexible mobility benefits of such a wheel, but that supports more robust construction and more efficient, expeditious, and reliable production.

### BRIEF SUMMARY

A wheel assembly comprises multiple wheels, each featuring a wheel hub with a main axle bore and a peripheral axle ring formed by overmolded cross roller sub-assemblies. The cross roller sub-assemblies include pre-roller assemblies with symmetrical axles and solid bushings, and peripheral rollers. The wheel hubs have interlocking faces that allow the wheels to be placed in close proximity to each other.

To assemble the wheel assembly, pre-roller assemblies are first overmolded with peripheral rollers to form cross roller sub-assemblies. These sub-assemblies are then placed in a mold and overmolded with a wheel hub to form the peripheral axle ring. Alternatively, pre-roller assemblies may be placed in the mold and overmolded with the wheel hub without forming cross roller sub-assemblies.

In some embodiments, the wheel hubs feature interlocking faces that allow two or more wheels to be interlocked by bringing their faces together. The interlocking faces include center hub protrusions, center hub recesses, outer hub protrusions, and outer hub recesses. When interlocked, these faces place the wheels in close proximity to each other.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A-FIG. 1D illustrate various views of an omnidirectional roller wheel assembly 100 in accordance with one embodiment.

FIG. 3A-FIG. 3C illustrate omnidirectional roller wheel assembly configuration cross sections 300 in accordance with one embodiment.

FIG. 4A and FIG. 4B illustrate an interlocking face 400 of a wheel hub in accordance with one embodiment.

FIG. 5A and FIG. 5B illustrate a production process 500 in accordance with one embodiment.

FIG. 6 illustrates a method 600 in accordance with one embodiment.

FIG. 7 illustrates a pre-roller assembly timeline 700 in accordance with one embodiment.

FIG. 8 illustrates omnidirectional roller wheel movement degrees of freedom 800 in accordance with one embodiment.

FIG. 9 illustrates exemplary omnidirectional roller wheel configurations 900 in accordance with two embodiments.

FIG. 10 illustrates an omni-directional stackable nesting utility cart (ODSNUC) 1000 in accordance with one embodiment.

FIG. 11A and FIG. 11B illustrate a compression testing of the omnidirectional roller wheel assembly 1100 in accordance with one embodiment.

### DETAILED DESCRIPTION

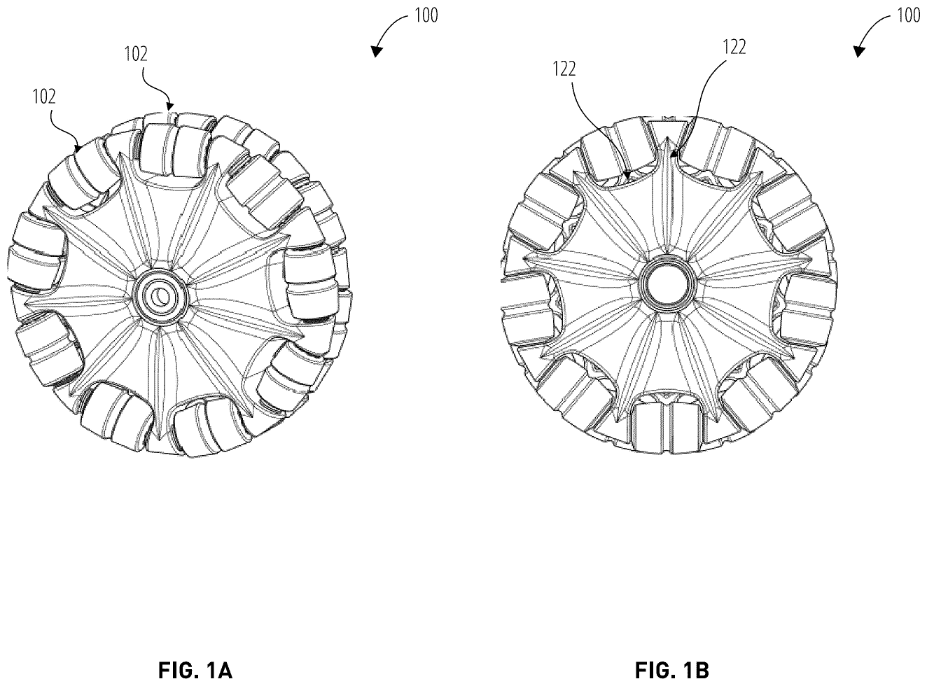

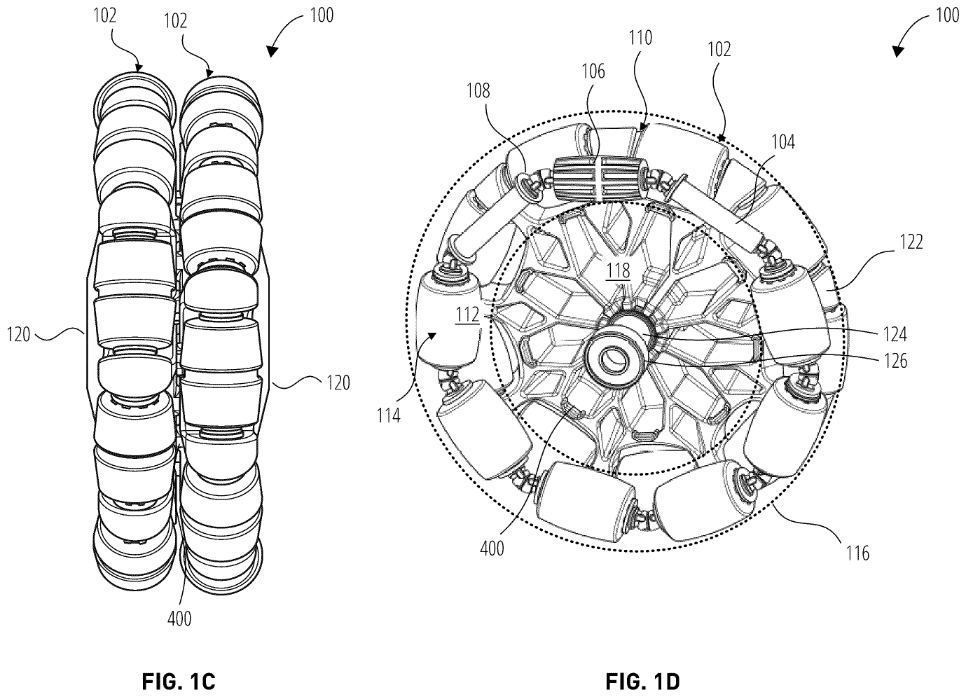

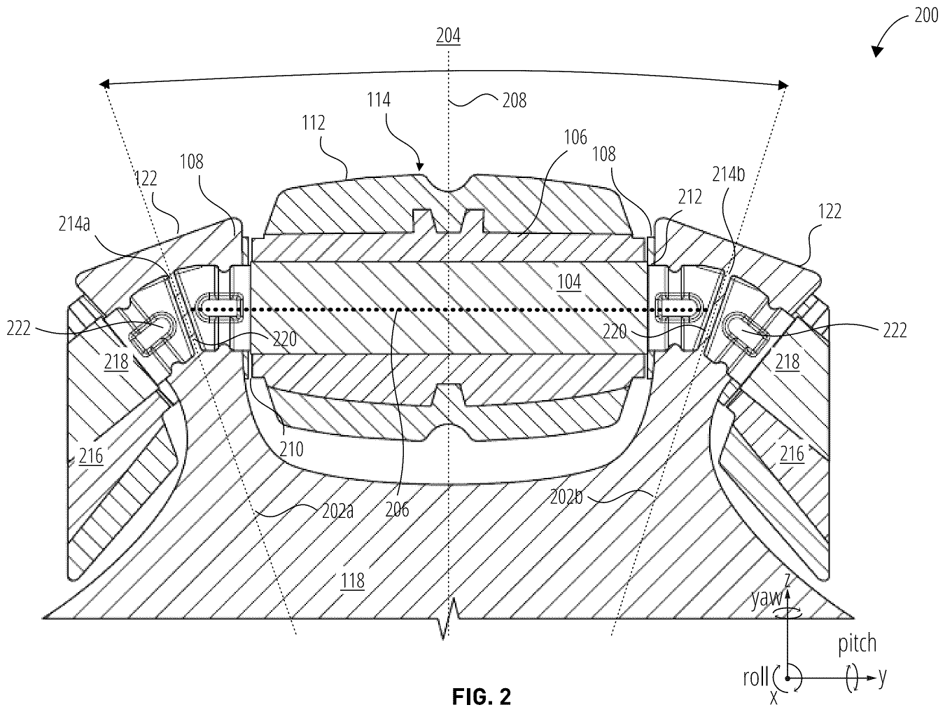

FIG. 1A-FIG. 1D illustrate various views of an omnidirectional roller wheel assembly 100 in accordance with one embodiment. FIG. 1A illustrates perspective view of the omnidirectional roller wheel assembly 100. FIG. 1B illustrates a side elevation view of the omnidirectional roller wheel assembly 100. FIG. 1C illustrates a front elevation view of the omnidirectional roller wheel assembly 100. FIG. 1D illustrates a perspective view of the omnidirectional roller wheel assembly 100 with some elements removed to show details of the individual elements making up the omnidirectional roller wheel assembly 100.

The omnidirectional roller wheel assembly 100 may comprise multiple omnidirectional roller wheels 102. In one embodiment, two omnidirectional roller wheels 102 may be included. In another embodiment, the omnidirectional roller wheel assembly 100 may include three omnidirectional roller wheels 102. Each omnidirectional roller wheel 102 may include a number of symmetrical axles 104, solid bushings 106, and washers 108 assembled as pre-roller assemblies 110, which may then incorporate peripheral rollers 112 to form cross roller sub-assemblies 114.

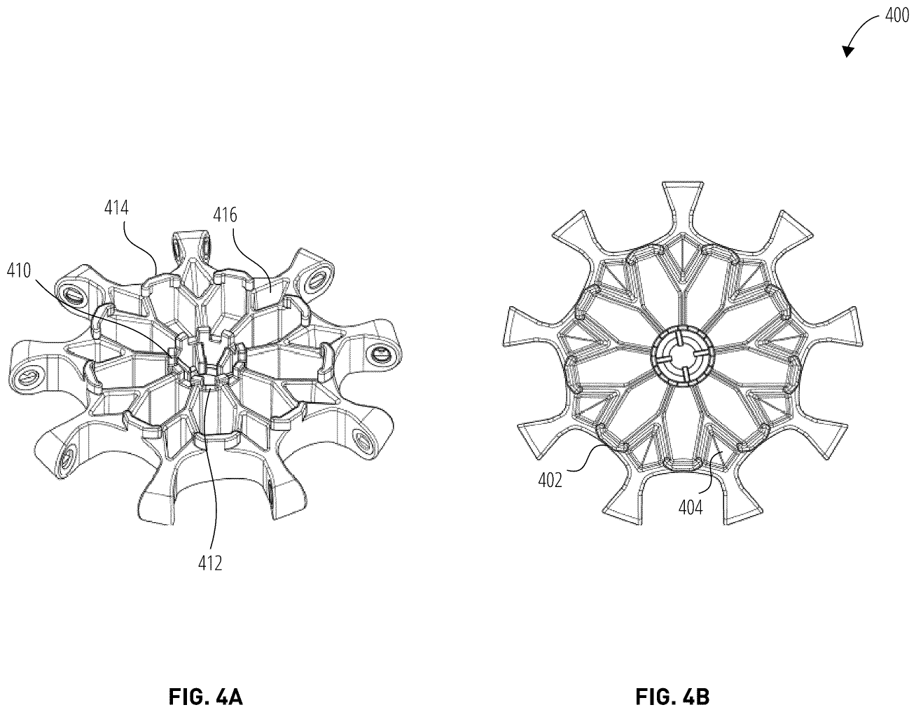

The cross roller sub-assemblies 114 may be configured in a peripheral axle ring 116 around a wheel hub 118 to form the complete omnidirectional roller wheel 102. The illustrated embodiment shows a wheel hub 118 with spokes 122 designed to accommodate nine cross roller sub-assemblies 114, but one of ordinary skill in the art will readily apprehend that other designs configured for other quantities of cross roller sub-assembly 114 are possible within the scope of the present disclosure. The wheel hub 118 may have an outer face 120 which may be smooth and may thus avoid catching upon nearby objects as the omnidirectional roller wheel assembly 100 facilitates transport of goods in a facility. The side of the wheel hub 118 opposite the outer face 120 may be configured as an interlocking face 400, described in greater detail below with respect to FIG. 4A and FIG. 4B.

Multiple omnidirectional roller wheels 102 may be configured along a common main axle 124 clement, and may include main axle bearings 126, by which each omnidirectional roller wheel 102 interfaces with the main axle 124 with reduced friction. The omnidirectional roller wheels 102 may be assembled from these components and may be incorporated into omnidirectional roller wheel assemblies 100 as disclosed in greater detail below.

In some embodiments, the overlapping surfaces of the solid bushing 106 and peripheral roller 112 have been minimized, thereby generating a substantial alignment of the edges and a continuity of the rollers in contact. The configuration may permit an increase in size of the spoke and the stiffness of the spoke.

In exemplary embodiments, the spokes may also have external ribs running from the center of the wheel hub to the end of the spokes, as seen in FIG. 1A and FIG. 1B.

FIG. 2 illustrates a peripheral axle ring configuration detail 200 in accordance with one embodiment. In FIG. 2, a cross roller sub-assembly 114 is shown in detail secured between spokes 122 of the wheel hub 118 previously introduced. The components of the cross roller sub-assembly 114 (i.e., the symmetrical axle 104, solid bushing 106, and peripheral roller 112) may be centered in the z dimension (and in the x dimension, though this is not shown) at the cross roller sub-assembly axis of rotation 206, and may be centered in the y dimension at a cross roller sub-assembly midline 208. The cross roller sub-assembly midline 208 may be considered as the geometrical line dividing the cross roller sub-assembly 114 in half longitudinally. The cross roller sub-assembly midline 208 may be a bisector of the central angle 204 formed by the wheel hub spoke bisector 202a and wheel hub spoke bisector 202b at the main axis 804 (introduced with respect to FIG. 8). Thus, within a reasonable manufacturing tolerance, the cross roller sub-assemblies 114 of a completed omnidirectional roller wheel 102 may be considered as being centered between adjacent spokes 122 of the wheel hub 118.

In one embodiment washers 108 may be included in the pre-roller assemblies 110 and may reside between each spoke 122 and the near side of the adjacent cross roller sub-assembly 114 as shown. In this manner, the wheel hub 118 may securely capture the symmetrical axle 104 while allowing the peripheral roller 112 and solid bushing 106 to roll freely. The washers 108 may provide a clean shut-off surface, and may eliminate a knife-edge feature in a tool. The washers 108 may be fused to the wheel hub 118 and the symmetrical axle 104 during overmolding.

Shut-off regions may provide a gap 210 between each spoke 122 and the side of the adjacent cross roller sub-assembly 114. In this manner, the wheel hub 118 may securely capture the symmetrical axle 104 while allowing the peripheral roller 112 and solid bushing 106 to roll freely. The overmolding of the wheel hub 118 may be performed with shut-off regions that prevent impingement of the overmold material upon the washers 108, or the washers 108 may act to shut off material from interfering with the symmetrical axle 104, the solid bushing 106, and/or the peripheral roller 112 of the cross roller sub-assembly 114. In one embodiment, each end of the symmetrical axle 104 may be configured with a small shelf 212, which may control how far the washers 108 are pressed onto the axles and may maintain the gap 210 that prevents them from binding the peripheral roller 112.

The cross roller sub-assembly 114 may be dimensioned and disposed such that the chamfered side 220 of the symmetrical axle 104 may be aligned with the wheel hub spoke bisector 202a as shown while providing clearance 214a to prevent interference between the symmetrical axle 104 of the cross roller sub-assembly 114 and an adjacent symmetrical axle 218 of an adjacent cross roller sub-assembly 216. Similarly, the opposite chamfered side 220 may be aligned with the wheel hub spoke bisector 202b while providing clearance 214b. These clearances between the chamfered sides 220 of the symmetrical axle 104 and the corresponding chamfered sides 220 of adjacent symmetrical axles 218 of adjacent cross roller sub-assemblies 216 may be uniform along their lengths in alignment with their intervening wheel hub spoke bisectors, as shown here by the clearance 214a between the symmetrical axle 104 and the adjacent symmetrical axle 218. In one embodiment, the chamfered sides 220 of the symmetrical axle 104 may include indentations 222 as shown or protrusions, rather than a uniformly flat surface. In such an embodiment, clearance 214a may not be uniform along the wheel hub spoke bisector 202a, but adjacent chamfered sides 220 may exhibit a symmetrical, mirrored clearance profile.

In some embodiments, the symmetrical axles are cross rolling pins.

In some embodiments, the ends of the spokes 122 have a flat external surface as shown in FIG. 2, which maintains the same distance with the external diameter of the wheel.

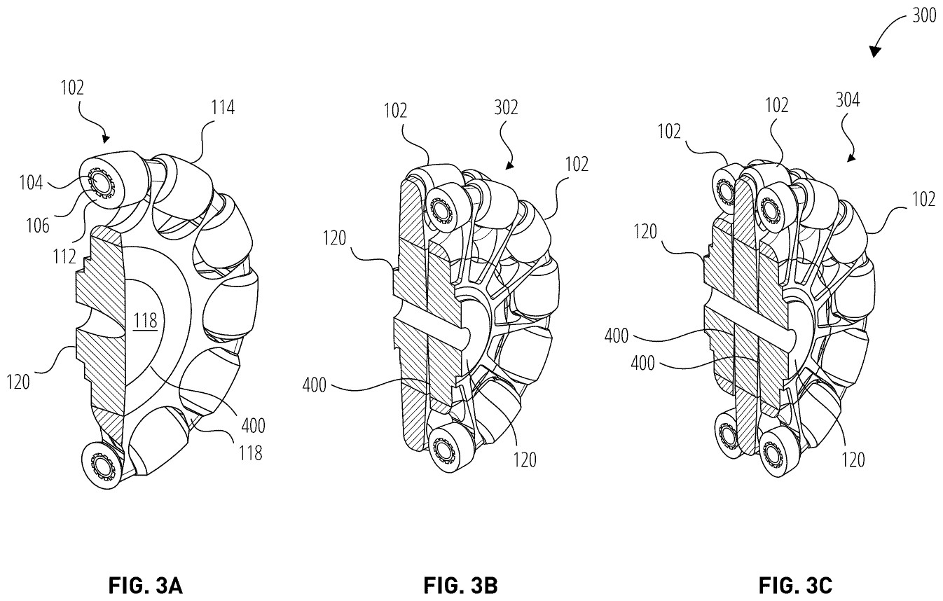

FIG. 3A-FIG. 3C illustrate omnidirectional roller wheel assembly configuration cross sections 300 in accordance with one embodiment. FIG. 3A shows an omnidirectional roller wheel 102 in cross-section, FIG. 3B shows two omnidirectional roller wheels 102 assembled as a double omnidirectional roller wheel assembly 302 in cross-section, and FIG. 3C shows three omnidirectional roller wheels 102 assembled as a triple omnidirectional roller wheel assembly 304 in cross-section.

In one embodiment, the wheel hub 118 of the omnidirectional roller wheel 102 may have an interlocking face 400 and an outer face 120. In FIG. 3A-FIG. 3C the interlocking faces 400 shown are illustrated in a simplified manner, but may include details such as are introduced with respect to FIG. 4A and FIG. 4B. When assembled to form the double omnidirectional roller wheel assembly 302, the interlocking faces 400 of the two wheels may face each other as shown in FIG. 3B, with both outer-facing sides of the joined wheels being their outer faces 120. In one embodiment, wheels having two interlocking faces 400 may be configured between wheels having outer faces 120 opposite their interlocking faces 400 as shown in FIG. 3C. One of ordinary skill in the art will readily apprehend that the two wheels of the double omnidirectional roller wheel assembly 302 and the three wheels of the triple omnidirectional roller wheel assembly 304 may be otherwise configured in a manner that supports solid and steady contact among the wheels, preventing independent in-line motion 806 (described further in FIG. 8) of any wheel with respect to the others.

As shown in FIG. 3B and FIG. 3C, omnidirectional roller wheels 102 placed side by side to form the double omnidirectional roller wheel assembly 302 and the triple omnidirectional roller wheel assembly 304 may be rotated with respect to each other so as to align the cross roller sub-assembly midlines (such as the cross roller sub-assembly midline 208 illustrated in FIG. 2) of one omnidirectional roller wheel 102 with the wheel hub spoke bisectors (such as the wheel hub spoke bisectors 202a and 202b) between cross roller sub-assemblies 114 of the adjacent omnidirectional roller wheel 102, such that the circumferences of the double omnidirectional roller wheel assembly 302 and the triple omnidirectional roller wheel assembly 304 contain no gaps between cross roller sub-assemblies 114 in contact with a surface of motion (e.g., floor or ground surface), supporting case of transverse motion 808 of the omnidirectional roller wheel assembly 100 as shown in FIG. 8. For example, with omnidirectional roller wheels 102 having twelve cross roller sub-assemblies 114, a rotation of 15 degrees from one omnidirectional roller wheel 102 to the next omnidirectional roller wheel 102 may allow the peripheral rollers of one wheel to be centered in the gaps between peripheral rollers of the next wheel, providing an overall circumference with no gaps between cross roller sub-assemblies 114.

FIG. 4A and FIG. 4B illustrate an interlocking face 400 of the omnidirectional roller wheel 102 wheel hub 118 in accordance with one embodiment. FIG. 4A illustrates a perspective view of the interlocking face 400. FIG. 4B shows an elevation view of the interlocking face 400 with the interlocking protrusions 402 and 404 highlighted.

The interlocking face 400 may be configured with protrusions 402 and 404 that are sized and positioned to interlock when two omnidirectional roller wheels 102 are placed with their interlocking faces 400 toward one another and one omnidirectional roller wheel 102 is rotated with respect to the other such that the wheel hub spoke bisectors of one omnidirectional roller wheel 102 align with the cross roller sub-assembly midlines of the other, as is described with respect to the double omnidirectional roller wheel assembly 302 and triple omnidirectional roller wheel assembly 304 of FIG. 3B and FIG. 3C.

In an embodiment, wheel hub includes an interlocking face with center hub protrusions 410, center hub recesses 412, outer hub protrusions 414, and outer hub recesses 416. In exemplary embodiments, the center hub protrusions and center hub recesses are configured to interlock with center hub recesses and center hub protrusions of another wheel of a plurality of wheels, with the other interlocking face. Additionally, in some embodiments, the outer hub protrusions and outer hub recesses are configured to interlock with outer hub recesses and outer hub protrusions of the other wheel with the other interlocking face. The the interlocking face and the other interlocking face, when interlocked, are adapted to place each wheel in close proximity to each other. In some embodiments, the clearance between contact surfaces of the two wheel hubs is zero. When the clearance is zero, there may be better propagation of energy during ultrasonic welding.

In the interlocking face 400 design illustrated here, two concentric sets of interlocking features (protrusion 402 and 404) are shown. One of ordinary skill in the art will recognize that other embodiments may utilize more or fewer interlocking features, and features of different shaping and spacing, than those shown, while remaining within the scope of this disclosure.

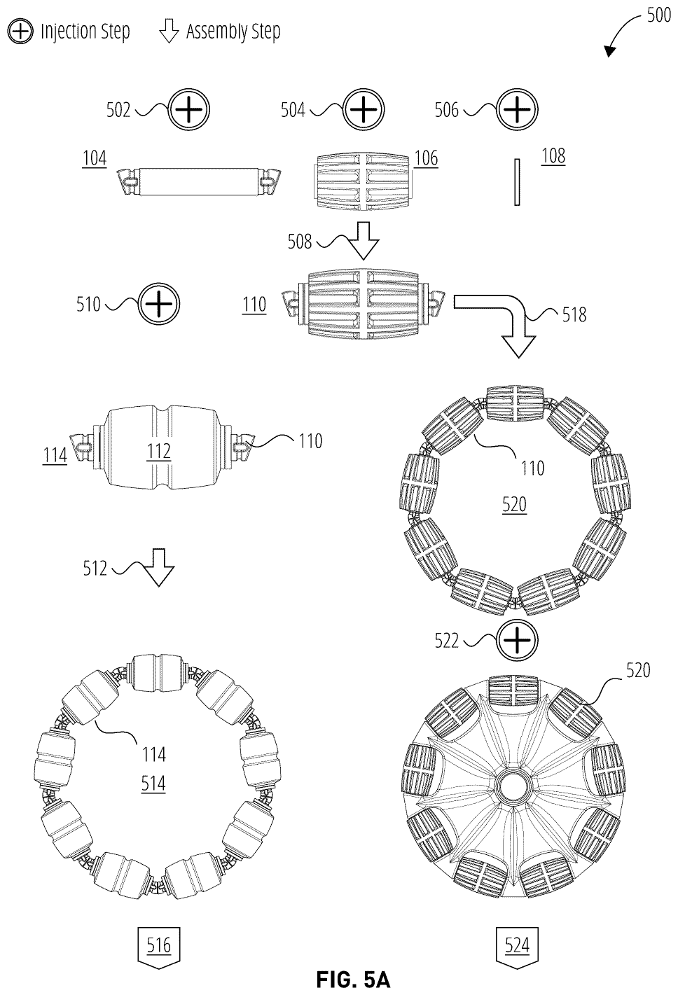

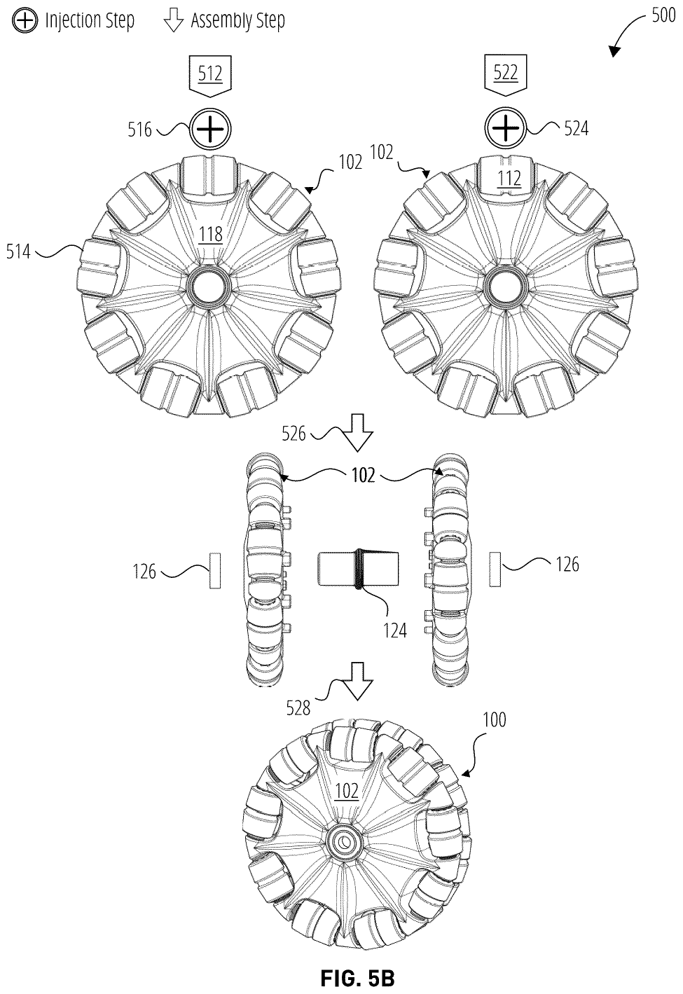

FIG. 5A and FIG. 5B illustrate a production process 500 in accordance with one embodiment. The production process 500 may primarily comprise injection steps and assembly steps, which are indicated by the symbols shown.

The production process 500 may begin with injection steps 502, 504, and 506, by which the symmetrical axles 104, solid bushings 106, and washers 108 are created, respectively. These steps are not confined to their numbered order, as will be well understood by one of ordinary skill in the art. The injection steps 502 and 506 may utilize simple, multi-cavity molds, such as eight-cavity molds. Injected materials may include Nylon 66 Super Tough, BASF PA6, PA66, and PAI. Injection step 504 may utilize a four-cavity mold and materials including acetal copolymer, BASF POM Standard, and Super Lube.

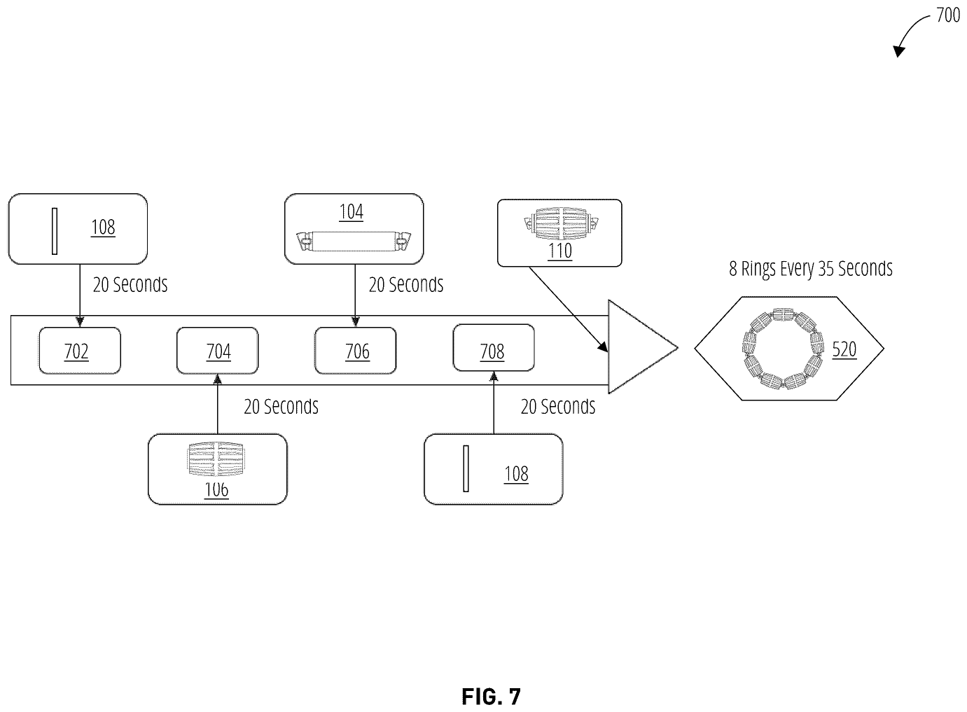

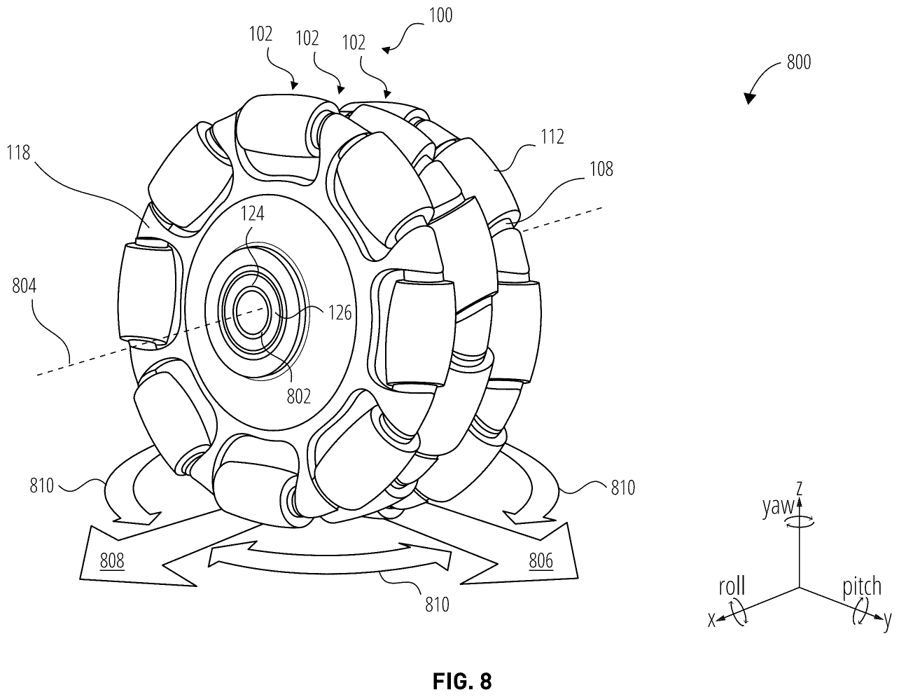

An assembly step 508 may assemble each symmetrical axle 104 and solid bushing 106, along with two washers 108, into a pre-roller assembly 110. Additional description is provided with respect to the pre-roller assembly timeline 700 of FIG. 7. After assembly step 508, the production process 500 branches into different options for manufacture of additional portions of the omnidirectional roller wheel 102.

In one option the injection step 510 may create cross roller sub-assemblies 114 in one embodiment by overmolding peripheral rollers 112 onto the pre-roller assemblies 110. The injection step 510 may involve a bulk overmolding process where a number of pre-roller assemblies 110 may be overmolded with peripheral rollers 112 to form cross roller sub-assemblies 114 at once. Materials for the overmolded peripheral rollers 112 may include TPU 8A, 90A, and 95A. In one embodiment, the peripheral rollers 112 may be injection molded from these materials instead and placed on the pre-roller assemblies 110 as part of an assembly step.

In assembly step 512, the desired number of cross roller sub-assemblies 114 may be placed in a cross roller sub-assembly ring 514 within a mold configured for overmolding a wheel hub 118. The production process 500 may then proceed to injection step 516, where the wheel hub 118 is overmolded onto the cross roller sub-assembly ring 514. The mold for the wheel hub 118 may be a four cavity mold with a switch in one embodiment. The wheel hub 118 may be overmolded using materials including Nylon 66 Super Tough, BASF PA 6, and PA66. In this manner, an omnidirectional roller wheel 102 may be formed through the production process 500 following injection steps 502-506, assembly step 508, injection step 510, assembly step 512, and injection step 516.

In one option, the desired quantity of the pre-roller assemblies 110 created in assembly step 508 may be placed in a mold configured for overmolding the wheel hub 118 as part of assembly step 518, forming a pre-roller assembly ring 520 in that mold. The mold may be a four-cavity mold with a switch. The wheel hub 118 may be overmolded in injection step 522 using materials including Nylon 66 Super Tough, BASF PA 6, and PA66. The production process 500 may then proceed to injection step 524. In injection step 524, the peripheral rollers 112 may be overmolded onto the pre-roller assemblies 110 of the pre-roller assembly ring 520. Materials for the overmolded peripheral rollers 112 may include TPU 8A, 90A, and 95A. In this manner, an omnidirectional roller wheel 102 may be formed through the production process 500 following injection steps 502-506, assembly step 508, assembly step 518, injection step 522, and injection step 524.

As illustrated in FIG. 5B, in assembly step 526 multiple omnidirectional roller wheels 102 may be assembled with a main axle bearing 126 for each omnidirectional roller wheel 102 and a main axle 124. The main axle 124 may maintain the omnidirectional roller wheels 102 along a common axis of rotation in an in-line motion 806, described in greater detail with respect to the omnidirectional roller wheel movement degrees of freedom 800 of FIG. 8. The main axle bearings 126 may reduce the friction between the omnidirectional roller wheels 102 and the main axle 124, preventing wear and prolonging the life of the omnidirectional roller wheels 102.

Assembly step 528 may finally bring the two (or more) omnidirectional roller wheels 102 together into a completed omnidirectional roller wheel assembly 100. The assembly step 528 may include rotation such that the protrusions 402 and 404 of the interlocking faces 400 previously described interlock. The assembly step 528 may additionally include ultrasonic welding to physically bind the interlocking faces 400 of the omnidirectional roller wheels 102 together to prevent their rotational motion with respect to each other as well as linear motion away from each other.

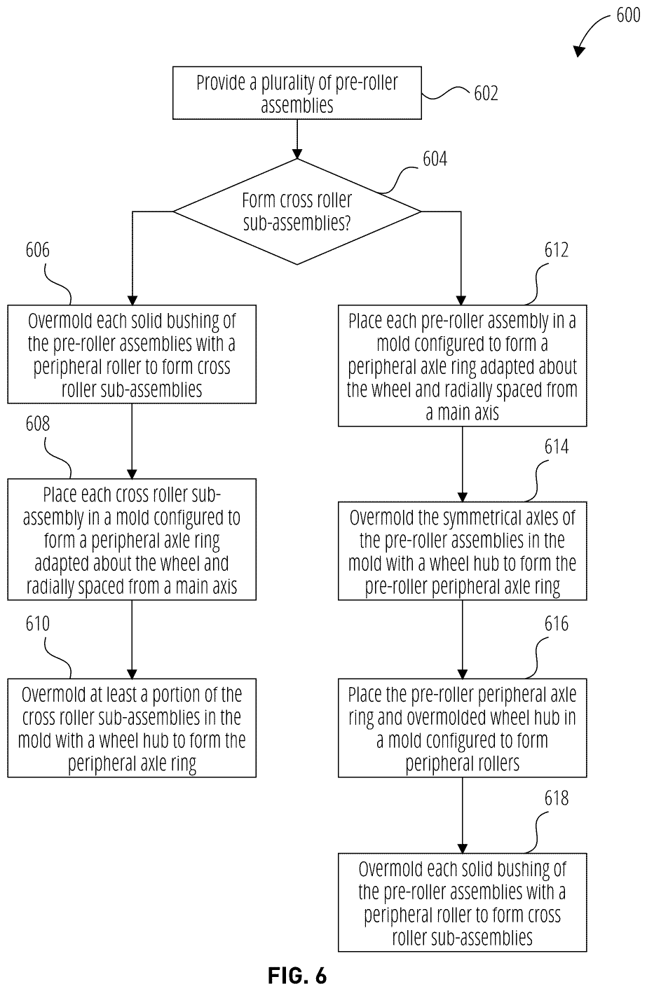

FIG. 6 illustrates an example method 600 for manufacturing an omnidirectional wheel. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method includes providing a plurality of pre-roller assemblies at block 602. Each pre-roller assembly may include a symmetrical axle and a solid bushing. In one embodiment, each pre-roller assembly may further include two washers disposed on either end of the assembled symmetrical axle and solid bushing. The symmetrical axles may be injection molded. They may have a chamfered side on each end. Each symmetrical axle may be oriented with each chamfered side aligned with a wheel hub spoke bisector of the overmolded wheel hub formed as described below. Each chamfered side may be spaced the same distance from the wheel hub spoke bisector as the chamfered side of an adjacent symmetrical axle of an adjacent cross roller sub-assembly. Each solid bushing may be configured to receive one symmetrical axle in a central longitudinal bore. The solid bushing may be injection molded with an inside diameter of the central longitudinal bore being slightly larger than the diameter of the symmetrical axles. The solid bushings may have a cylindrical outer diameter in one embodiment. The solid bushings may have a spherical outer diameter in one embodiment.

According to some examples, the method includes forming cross roller sub-assemblies at decision block 604. If the manufacturing process involves next forming the cross roller sub-assemblies, as indicated at decision block 604, proceed to block 606. Otherwise, proceed to block 1308. In some embodiments, on condition the cross roller sub-assemblies have not been formed the method includes placing, in the mold, each pre-roller assembly, the mold configured to form a pre-roller peripheral axle ring adapted about the wheel and radially spaced from the main axis and overmolding the symmetrical axles of the pre-roller assemblies in the mold with the wheel hub to form the pre-roller peripheral axle ring, wherein the wheel hub includes the main axle bore rotatable around the main axis.

According to some examples, the method includes overmold each solid bushing of the pre-roller assemblies with a peripheral roller to form cross roller sub-assemblies at block 606.

According to some examples, the method includes placing each cross roller sub-assembly in a mold configured to form a peripheral axle ring adapted about the wheel and radially spaced from a main axis at block 608.

According to some examples, the method includes overmold at least a portion of the cross roller sub-assemblies in the mold with a wheel hub to form the peripheral axle ring at block 610. The wheel hub may include a main axle bore rotatable around the main axis. The wheel hub may comprise a number of spokes. Each cross roller sub-assembly may be secured between two spokes of the overmolded wheel hub. The wheel hub may comprise an inner wheel hub and an outer wheel hub. The inner wheel hub may be placed in the mold with the cross roller sub-assemblies in block 608. The inner wheel hub and the symmetrical axles of the cross roller sub-assemblies may both then be overmolded with the outer wheel hub to form the wheel hub in block 610. Shut-off regions may be provided in the mold. Overmolding material may thereby be prevented from interfering with at least one of the plurality of symmetrical axles, the plurality of solid bushings, and the plurality of peripheral rollers of the cross roller sub-assemblies. In some embodiments, the overmolding of each pre-roller assembly with the peripheral roller occurs after the overmolding of the symmetrical axles of the pre-roller assemblies.

According to some examples, the method includes placing each pre-roller assembly in a mold configured to form a peripheral axle ring adapted about the wheel and radially spaced from a main axis at block 612.

According to some examples, the method includes overmold the symmetrical axles of the pre-roller assemblies in the mold with a wheel hub to form the pre-roller peripheral axle ring at block 614. The wheel hub may include a main axle bore rotatable around the main axis. The wheel hub may comprise a number of spokes. Each pre-roller assembly may be secured between two spokes of the overmolded wheel hub. The wheel hub may comprise an inner wheel hub and an outer wheel hub. The inner wheel hub may be placed in the mold with the cross roller sub-assemblies in block 608. The inner wheel hub and the symmetrical axles of the cross roller sub-assemblies may both then be overmolded with the outer wheel hub to form the wheel hub in block 610. First shut-off regions may be provided in the mold, thereby preventing the overmolding material from interfering with at least one of the plurality of symmetrical axles, and the plurality of solid bushings of the pre-roller assemblies.

According to some examples, the method includes placing the pre-roller peripheral axle ring and overmolded wheel hub in a mold configured to form peripheral rollers at block 616.

According to some examples, the method includes overmold each solid bushing of the pre-roller assemblies with a peripheral roller to form cross roller sub-assemblies at block 618. Shut-off regions may be provided in the mold for overmolding each solid bushing of the plurality of pre-roller assemblies with the peripheral roller. Overmolding material may thereby be prevented from interfering with at least one of the plurality of symmetrical axles, the plurality of solid bushings, and the plurality of peripheral rollers of the cross roller sub-assemblies.

FIG. 7 illustrates a pre-roller assembly timeline 700 in accordance with one embodiment. In step 702, a washer 108 may be picked from a supply of multiple washers 108 formed according to production process 500. In step 704, a solid bushing 106 may be picked from a supply of multiple solid bushings 106. In step 704, a symmetrical axle 104 may be picked from a supply of multiple symmetrical axles 104. The washer 108 and symmetrical axle 104 picked in step 702 and step 704 respectively may be assembled onto the symmetrical axle 104 picked in step 706. A washer 108 may be picked from the supply of washers 108 at step 708 and may be assembled with the other components to form the pre-roller assembly 110. In a typical process, eight pre-roller assembly rings 520 formed from nine pre-roller assemblies 110 each may be formed every thirty-five seconds.

FIG. 8 illustrates omnidirectional roller wheel movement degrees of freedom 800 in accordance with one embodiment. The omnidirectional roller wheels 102 of an omnidirectional roller wheel assembly 100 may roll in an in-line motion 806 as conventional wheels do, in a roll rotation around the main axis 804 that runs through the center of the main axle bore 802. However, if in-line motion 806 of the wheel hub 118 around the main axis 804 is arrested, or the desired movement of equipment configured with the omnidirectional roller wheels 102 is perpendicular to the in-line motion 806, the omnidirectional roller wheels 102 may also be capable of side-to-side or transverse motion 808, due to the pitch rotation of the cross roller sub-assemblies 114 of the peripheral axle ring 116 configured along the perimeter of the wheel hub 118.

Note that the omnidirectional roller wheels 102 disclosed herein may be prevented from moving in a swivel motion 810 (yaw rotation) to allow quicker and more secure stacking of equipment configured with such wheels. The primary benefit of omnidirectional roller wheels 102 may be their maneuverability in tight spaces, even when swivel motion 810 is prevented.

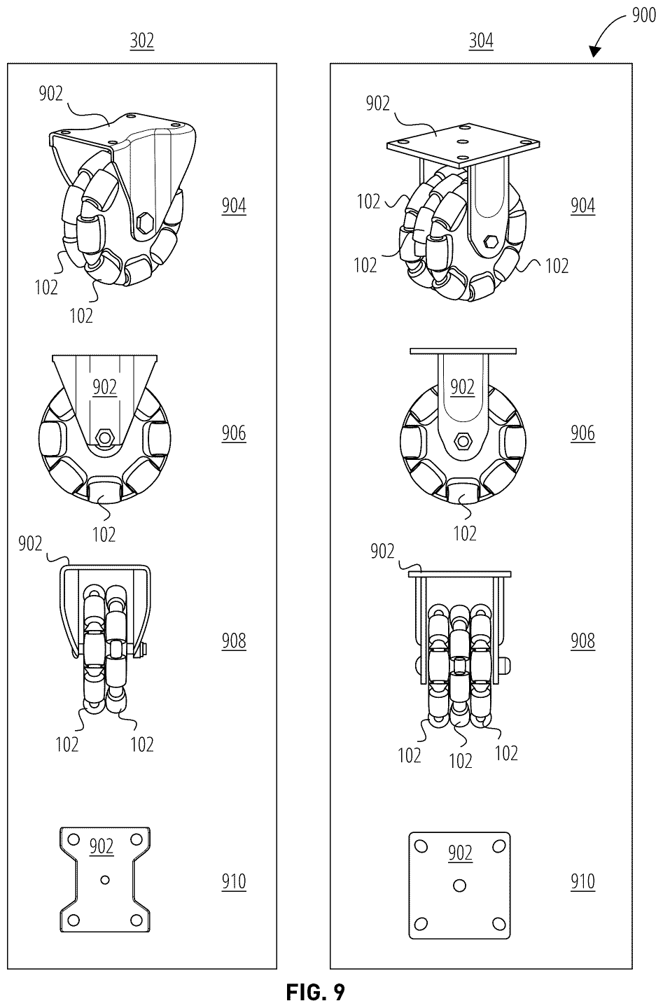

FIG. 9 illustrates exemplary omnidirectional roller wheel configurations 900 in accordance with one embodiment. The exemplary omnidirectional roller wheel configurations 900 may include a double omnidirectional roller wheel assembly 302, similar to a Rotacaster R2 wheel, and a triple omnidirectional roller wheel assembly 304, similar to a Rotacaster R3 wheel, and wheel brackets 902 for each configuration. An isometric view 904, a side elevation view 906, a front elevation view 908, and a plan view of the wheel bracket 910 are shown for each of the exemplary omnidirectional roller wheel configurations 900.

The exemplary omnidirectional roller wheel configurations 900 may have several steel mounts available for each example. These wheels may be manufactured with a slimmer profile than is possible when using plastic. This may make them easier to nest and may improve nesting density for nestable equipment using the omnidirectional roller wheels 102. One downside to using this type of wheel is that they may need additional assembly and hardware to attach them to the cart deck using the wheel brackets 902.

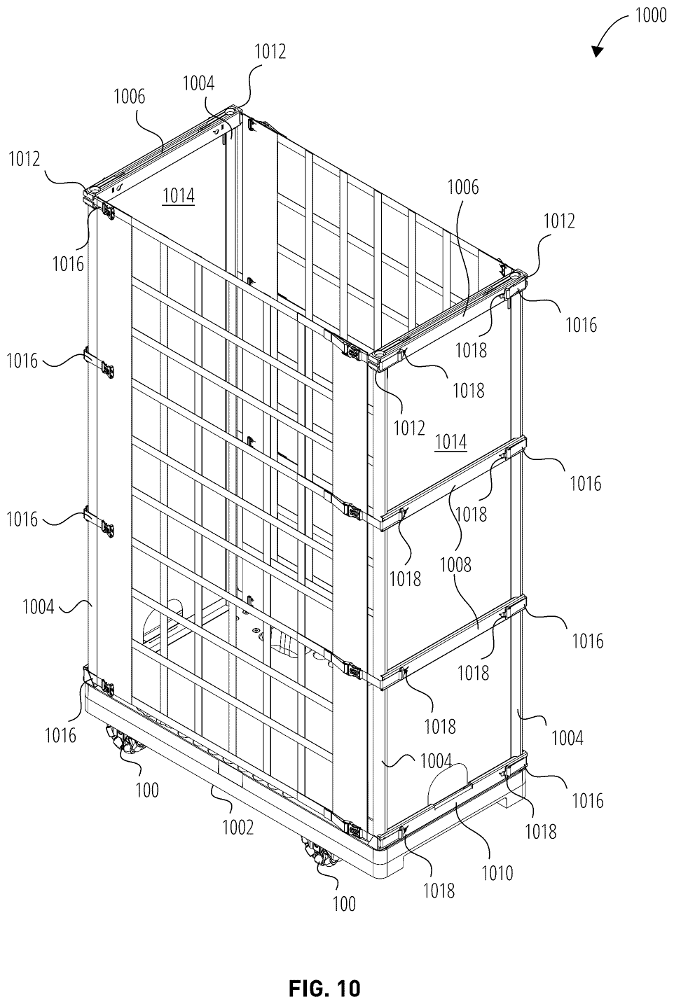

FIG. 10 illustrates an ODSNUC 1000 in accordance with one embodiment. The ODSNUC 1000 comprises a cart deck 1002, omnidirectional roller wheel assemblies 100, tubing 1004, top cross members 1006, middle cross members 1008, a bottom cross members 1010, frame locking blocks 1012, fabric backplanes 1014, tension straps 1016, and tension strap holding clips 1018.

The omnidirectional roller wheel assemblies 100 may be manufactured and configured as disclosed herein. The omnidirectional roller wheel assemblies 100 may facilitate a high level of maneuverability of the ODSNUC 1000. In this manner the omnidirectional roller wheel assembly 100 may allow the ODSNUC 1000 to operate well in transporting objects and materials in crowded environments or environments with limited room for maneuver.

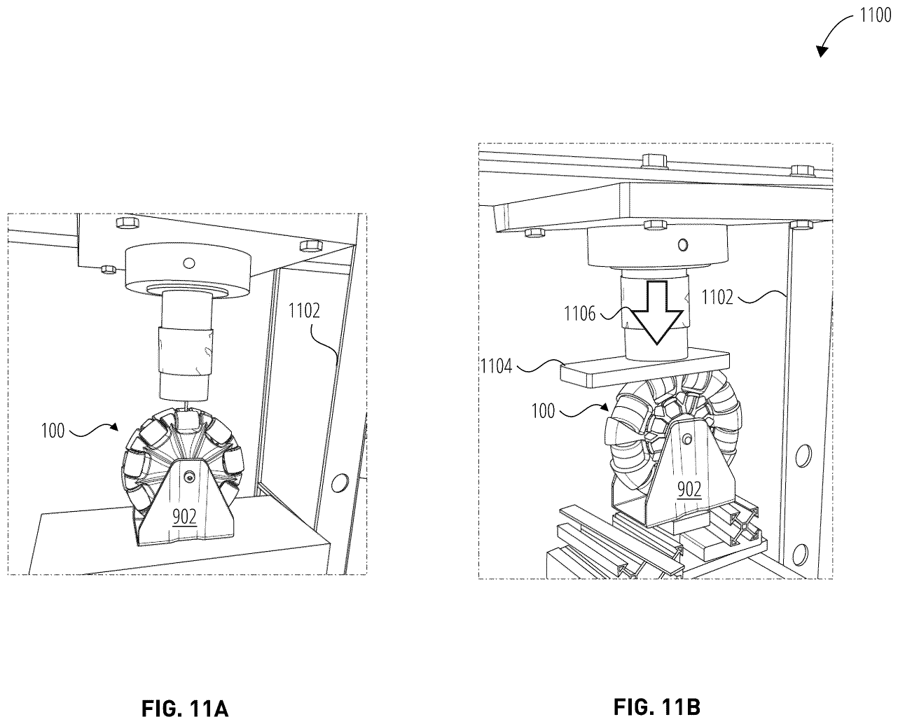

FIG. 11A and FIG. 11B illustrate a compression testing of the omnidirectional roller wheel assembly 1100 in accordance with one embodiment. An omnidirectional roller wheel assembly 100, including a wheel bracket 902, may be placed in a compression test rig 1102 as shown in FIG. 11A. A spreader plate 1104 may be placed atop the omnidirectional roller wheel assembly 100 in order to spread the compression force 1106 applied by the compression test rig 1102 along a portion of the omnidirectional roller wheel 102 in a manner that mimics the compression the omnidirectional roller wheel assembly 100 may experience when attached to a cart deck at rest on a floor or ground surface.

One embodiment of the disclosed wheely may be tested by the compression test rig 1102 applying a compression force 1106 of 1790 kg or pressure to the omnidirectional roller wheel assembly 100. The disclosed omnidirectional roller wheel assembly 100 may withstand this pressure, while other similar wheels have been tested and withstood only 900 kg of pressure. Where PA6 material is used in the production process 500 described above, the elements formed from this material may get stronger as they absorb moisture. The disclosed omnidirectional roller wheel assembly 100, therefore, utilizing PA6 as previously described, may be highly suitable for use in damp or wet environments.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. Thus, an entity described or recited as “configured to” perform some task refers to something physical. The term “configured to” is not intended to mean “configurable to.” Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifics that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an

exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of this disclosure as claimed. The scope of disclosed subject matter is not limited to the depicted embodiments but is rather set forth in the following Claims.

What is claimed is:

1. A wheel assembly comprising:
a plurality of wheels, each wheel comprising:
a wheel hub including a plurality of spokes and a main axle bore rotatable around a main axis;
a plurality of cross roller sub-assemblies comprising:
a plurality of pre-roller assemblies including:
a plurality of symmetrical axles; and
a plurality of solid bushings, each solid bushing configured to receive one symmetrical axle in a central longitudinal bore; and
a plurality of peripheral rollers, each pre-roller assembly overmolded with one peripheral roller;
a peripheral axle ring adapted about each wheel and radially spaced from the main axis, each wheel having the plurality of cross roller sub-assemblies overmolded with the wheel hub,
wherein the overmolded cross roller sub-assemblies form the peripheral axle ring.

2. The wheel assembly of claim 1, wherein the wheel hub comprises:
an interlocking face including:
center hub protrusions;
center hub recesses;
outer hub protrusions; and
outer hub recesses,
wherein the center hub protrusions and the center hub recesses are configured to interlock with center hub recesses and the center hub protrusions of another wheel of the plurality of wheels, with another interlocking face, and
wherein the outer hub protrusions and the outer hub recesses are configured to interlock with outer hub recesses and the outer hub protrusions of the another wheel of the plurality of wheels, with the another interlocking face,
wherein the interlocking face and the another interlocking face, when interlocked, are adapted to place each wheel in close proximity to each other.

3. The wheel assembly of claim 2, wherein the interlocked wheels are ultrasonically welded to bind the interlocking faces together.

4. The wheel assembly of claim 2, wherein wheel hub spoke bisectors of one omnidirectional roller wheel align with cross roller sub-assembly midlines of the other, wherein the cross roller sub-assembly midline is a geometrical line dividing the cross roller sub-assembly in half longitudinally, and the cross roller sub-assembly midline is a bisector of a central angle formed by each wheel hub spoke bisector and each wheel hub spoke bisector at the main axis.

5. The wheel assembly of claim 1, wherein each cross roller sub-assembly of the plurality of the cross roller sub-assemblies is secured between two spokes of the overmolded wheel hub.

6. The wheel assembly of claim 1, wherein the symmetrical axles have a chamfered side on each end.

7. The wheel assembly of claim 6, wherein each cross roller sub-assembly is secured between two spokes of the overmolded wheel hub, and
wherein each symmetrical axle is oriented with each chamfered side aligned with a wheel hub spoke bisector, and
wherein each chamfered side is spaced the same distance from the wheel hub spoke bisector as the chamfered side of an adjacent symmetrical axle of an adjacent cross roller sub-assembly.

8. The wheel assembly of claim 1, wherein the symmetrical axles are cross rolling pins.

9. A method of assembling a wheel assembly, the method comprising:
providing:
a plurality of wheels, each wheel comprising:
a wheel hub including a plurality of spokes and a main axle bore rotatable around a main axis;
a plurality of pre-roller assemblies including:
a plurality of symmetrical axles; and
a plurality of solid bushings, each solid bushing configured to receive one symmetrical axle in a central longitudinal bore;
overmolding each solid bushing of the plurality of pre-roller assemblies with a peripheral roller to form a plurality of cross roller sub-assemblies;
on condition the cross roller sub-assemblies have been formed:
placing, in a mold, each cross roller sub-assembly of the plurality of cross roller sub-assemblies, the mold configured to form a peripheral axle ring adapted about the wheel and radially spaced from the main axis; and
overmolding at least a portion of the cross roller sub-assemblies in the mold with the wheel hub to form the peripheral axle ring, wherein the wheel hub includes a main axle bore rotatable around the main axis;
on condition the cross roller sub-assemblies have not been formed:
placing, in the mold, each pre-roller assembly of the plurality of pre-roller assemblies, the mold configured to form a pre-roller peripheral axle ring adapted about the wheel and radially spaced from the main axis; and
overmolding the symmetrical axles of the pre-roller assemblies in the mold with the wheel hub to form the pre-roller peripheral axle ring, wherein the wheel hub includes the main axle bore rotatable around the main axis.

10. The method of claim 9, wherein the overmolding of each pre-roller assembly with the peripheral roller occurs after the overmolding of the symmetrical axles of the pre-roller assemblies.

11. The method of claim 9, the method further comprising:
interlocking two or more of the plurality of wheels by bringing an interlocking face of each wheel together with the interlocking face an adjacent wheel,
wherein the wheel hub comprises:
the interlocking face including:
center hub protrusions;
center hub recesses;
outer hub protrusions; and
outer hub recesses,
wherein the center hub protrusions and the center hub recesses are configured to interlock with center hub recesses and the center hub protrusions of another wheel of the plurality of wheels, with another interlocking face, and
wherein the outer hub protrusions and the outer hub recesses are configured to interlock with outer hub recesses and the outer hub protrusions of the another wheel of the plurality of wheels, with the another interlocking face,
wherein the interlocking face and the another interlocking face, when interlocked, are adapted to place each wheel in close proximity to each other.

12. The method of claim 11, further comprising ultrasonically welding the interlocked wheels to bind the interlocking faces together.

13. The method of claim 11, wherein wheel hub spoke bisectors of one omnidirectional roller wheel align with cross roller sub-assembly midlines of the other, wherein the cross roller sub-assembly midline is a geometrical line dividing the cross roller sub-assembly in half longitudinally, and the cross roller sub-assembly midline is a bisector of a central angle formed by each wheel hub spoke bisector and each wheel hub spoke bisector at the main axis.

14. The method of claim 9, further comprising:
providing shut-off regions in the mold, for the overmolding of at least portions of the cross roller sub-assemblies in the mold, with the wheel hub, to form the peripheral axle ring, wherein an overmolding material does not interfere with at least one of the plurality of symmetrical axles, the plurality of solid bushings, and the plurality of peripheral rollers of the cross roller sub-assemblies.

15. The method of claim 9, further comprising:
providing first shut-off regions in the mold, for overmolding of the symmetrical axles of the pre-roller assemblies with the wheel hub, wherein an overmolding material does not interfere with at least one of the plurality of symmetrical axles, and the plurality of solid bushings of the pre-roller assemblies, and
providing second shut-off regions in the mold, for overmolding each solid bushing of the plurality of pre-roller assemblies with the peripheral roller,
wherein the overmolding of each solid bushing of the plurality of pre-roller assemblies with the peripheral roller occurs after the overmolding of the symmetrical axles with the wheel hub.

16. The method of claim 9, wherein each cross roller sub-assembly is secured between two spokes of the overmolded wheel hub.

17. The method of claim 16, wherein the symmetrical axles have a chamfered side on each end, the method further comprising:
orienting each symmetrical axle with each chamfered side aligned with a wheel hub spoke bisector; and
spacing each chamfered side the same distance from the wheel hub spoke bisector as the chamfered side of an adjacent symmetrical axle of an adjacent cross roller sub-assembly.

18. The method of claim 9, further comprising injection molding the plurality of solid bushings with an inside diameter slightly larger than the symmetrical axles, each solid bushing having a cylindrical outer diameter.

19. The method of claim 9, further comprising injection molding the plurality of solid bushings with an inside diameter slightly larger than the symmetrical axles, each solid bushing having a spherical outer diameter.

20. The method of claim 9, further comprising injection molding the symmetrical axles with a chamfered side on each end.
